(19) United States
(12) Patent Application Publication
(10) Pub. No.: US 2011/0305838 A1
(43) Pub. Date: Dec. 15, 2011

(54) METHOD OF PRODUCTION OF A DEPOSIT OF NANOPARTICLES WITH INCREASED ADHESION AND DEVICE FOR IMPLEMENTATION OF SUCH A METHOD

(75) Inventors: Hai Trieu Phan, Grenoble (FR); Jean-Antoine Gruss, Seyssinet (FR); Olivier Poncelet, Grenoble (FR)

(73) Assignee: COMMISSARIAT A L'ENERGIE ATOMIQUE ET AUX ENE ALT, PARIS (FR)

(21) Appl. No.: 13/143,242

(22) PCT Filed: Jan. 5, 2010
(86) PCT No.: PCT/EP2010/050022

§ 371 Date: Sep. 1, 2011

(30) Foreign Application Priority Data
Jan. 6, 2009 (FR) 09 50036

(51) Int. Cl. B05D 3/02; B05C 5/00

(52) U.S. Cl. 427/314; 118/50

(57) ABSTRACT

A device intended to accomplish the deposition of particles of nanometric size on at least one part of the surface (4) of a substrate (2), including a first enclosure (14) intended to contain a liquid (8) charged with particles (6) of nanometric size, in which the first enclosure (14) is subject to a pressure higher than atmospheric pressure, and including means of heating (16) the said fluid able to raise the fluid to its boiling temperature, a second enclosure (20) pressurised at a pressure roughly equal to that of the first enclosure (14), inside which the deposition by boiling occurs, in which means of heating (24) are provided to heat at least a part of the surface (4) of the substrate (2), and in which the first enclosure (14) is connected to the second enclosure (20) to allow the second enclosure (20) to be supplied with the fluid raised roughly to its boiling temperature.

### TECHNICAL FIELD AND PRIOR ART

The present invention relates to a method for depositing nanoparticles with improved adhesion, and to a device for the implementing such a method, for example for the production of thermal exchange surfaces with improved thermal specifications.

Thermal exchangers allow heat to be exchanged between a surface, called a thermal exchange surface, and a fluid. They often include non-open thermal exchange structures, such as complex-shaped, very large tubes or plates, the materials of which are diverse, such as metals, polymers or ceramics.

In evaporating on the surface the fluid extracts the heat from the surface, and movement is imparted to the fluid to release the extracted heat.

An important characteristic in the choice of a thermal exchange surface is its thermal resistance. Thermal resistance is proportional to the ratio 1/hS, where h is the thermal exchange coefficient between the exchange wall and the fluid, and S is the area of the exchange surface. It is sought to reduce this thermal resistance; but since area S is generally imposed the aim is therefore to increase h. It is possible to increase h by structuring the surface. In the case of applications with strong heat flows, it is sought to delay the appearance of the critical boiling flow, which corresponds to the appearance of a film of steam on the surface, and after which the thermal exchange degrades substantially. Overheating of the surface then occurs, which can lead to its destruction.

And it has been noted that surfaces having properties of great wettability had very satisfactory thermal transfer specifications when boiling. This observation was set out in the document: Y. Takata, S Hidaka, J M Cao, T. Nakamura, H. Yamamoto, M. Masuda, T. Ito, “Effect of Surface Wettability on boiling and evaporation”, in Energy 30 (2005) 209-220, the document: S. Ujereh, T. Fisher, I. Mudawar, “Effects of Carbon Nanotube Arrays on Nucleate Pool Boiling” in Int. J. of Heat and Mass Transfer 50 (2007) 4023-4038 and in the document S. Kim, H. Kim H. D., Kim, S. Ahn, M. H. Kim, J. Kim and G. C. Park, “Experimental Investigation of Critical Heat Flux Enhancement by Micro/Nanoscale Surface Modification in Pool Boiling”, ICNMM2008, Jun. 23-25, 2008, Darmstadt, Germany. Indeed, it was observed that, when the angle of contact of the drops of liquid on a surface was close to 0° the thermal exchange coefficient was substantially improved.

Surfaces having good wettability can be produced by depositing small particles on the said surface, for example nanometric particles, also called nanoparticles t, where these particles have good wettability properties for the fluid used in the thermal exchanger.

Such particles can be deposited on a surface by various methods.

A first type of method consists in depositing a thin film of particles on the surface.

A first method consists in depositing a film known as a LANGMUIR-BLODGETT film on the surface, where this film consists of a single layer or multiple layers of amphiphilic molecules, i.e. molecules having a hydrophilic end and a hydrophobic end. A drop of a solvent containing such molecules is introduced into a container filled with ultra-pure water. The molecules are distributed in the form of a film on the surface of the water. After the solvent evaporates the hydrophilic end of the molecules is aligned towards the water, and the hydrophobic end of the molecules is aligned away from the surface of the water.

The molecules gather so as to reduce the space between them, and the substrate to be covered is immersed perpendicularly to the surface of the water. The molecule film adheres to the substrate due to the capillary pressure. It is then possible to stack several tens of films. This technique is relatively complex and lengthy to implement. Furthermore, it applies only to substrates having a flat surface, or at least to surfaces with a relatively simple configuration.

It is also possible to use the Chemical Vapour Deposition (CVD), and more specifically the MOCVD (Metal Organic Chemical Vapour Deposition), method, or the PECVD (Plasma Enhanced Chemical Vapour Deposition) method. These methods apply to substrates where the surfaces to be covered are open and of limited size.

For example, MOCVD and PECVD apply only to substrates with a diameter of less than 25 cm. Indeed, it is difficult to control the homogeneity of the deposit on large-size surfaces.

In addition, these methods require very high deposit temperatures, of between 300° C. and 800° C., making them unworkable for deposits of particles on polymer substrates.

There is also another method to deposit particles on a surface, by which the deposit is obtained by boiling a solution containing nanoparticles, also called a nanofluid, at atmospheric pressure.

The deposit of nanoparticles at the surface of the substrate is explained by the evaporation of the liquid microfilm developed beneath each vapour bubble, where this nanofluid contains nanoparticles.

This method is described in document S. J. Kim, I. C. Bang, J Buongiorno, L. W. Hu, “Surfaces Wettability Change during Pool Boiling of Nanofluids and its effect on Critical Heat Flux”, Int. J. Heat and Mass Transfer 50 (2007) 4105-4116.

This method can apply to substrates of complex shape; however the film of nanoparticles produced in this manner does not adhere sufficiently to the substrate, since the film can easily be destroyed.

One aim of the present invention is consequently to offer a method for depositing small-size particles, more specifically nanoparticles, which is simple and able to apply to surfaces of complex shapes.

Another aim of the present invention is to offer thermal exchangers with greater efficiency.

### Account of the Invention

The aims previously set out are attained by nanostructuring of the surface of a substrate obtained by deposit of nanoparticles bringing into contact the surface to be covered with a nanofluid, in which the surface to be covered is also heated, and in which the nanofluid is maintained at a pressure higher than atmospheric pressure, such that the deposit occurs by boiling.

The effect of pressurising the nanofluid is to increase the boiling temperature, which enables the temperature to which the nanofluid can be heated to be increased, thus improving the adhesion of the deposit to the surface.

In other words, the conditions of the deposit are such that they allow deposition at a high boiling temperature, higher than the standard boiling temperature. These temperatures, however, enable deposits to be made on polymer substrates.

By altering the boiling temperature of the nanofluid the properties of the deposit of nanoparticles are substantially improved. The boiling temperature is the saturation temperature, and this temperature depends on the pressure.

For example, a pressure is applied to the nanofluid such that its boiling temperature is between 150° C. and 200° C.

Advantageously, the duration of the deposition phase is over 10 min., improving considerably the homogeneity of the deposit of nanoparticles.

In a variant embodiment, discrete zones of the substrate are heated in order to accomplish localised structuring, not total structuring of the surface of the substrate.

The main subject-matter of the present invention is therefore a method for depositing nanometric particles on at least a part of the surface of a substrate including the following steps:

a) heating of a liquid containing the said particles of nanometric size to a temperature close to its boiling temperature,

b) heating of the said at least part of the surface of the substrate to a temperature roughly equal to the said boiling temperature,

c) bringing the liquid into contact with the surface,

d) boiling of the liquid on the said surface at a temperature higher than its standard boiling temperature, causing the deposition of the said nanoparticles on the surface,

in which the said steps a), b) and c) occur at a pressure higher than atmospheric pressure.

Advantageously, step c) is accomplished by flowing the liquid along the surface, in which the flowing of the liquid along the surface takes place at slow speed, for example less than or equal to 0.1 m/s

For example, the applied pressure is between 5 bar and 10 bar, such that a boiling temperature of the fluid of between 150° C. and 200° C. is achieved.

The concentration of particles in the liquid is, for example, between 0.01% and 1% by mass.

The deposited particles may be TiO₂, SiO₂, alpha-Al₂O₃, gamma-Al₂O₃, boehmite AlO(OH), gibbsite Al (OH)₃), ZrO₂, HfO₂, SnO₂, Sb₂O₅, Ta₂O₅, Nb₂O₅, ZnO and/or silver, and the fluid is water or ethylene glycol.

In a variant embodiment the surface is heated in discrete areas.

Another subject-matter of the present invention is a method for producing a thermal exchange surface for a thermal exchanger implementing the method according to the present invention, where the deposited particles are particles with properties of good wettability for the thermal exchange fluid intended to be used in the thermal exchanger.

In an example embodiment, prior to the deposition of the particles having good wettability, a first phase is accomplished including steps a), b) and c), in which the particles are particles having low wettability for the said thermal exchange fluid, so as to form a layer of particles of low wettability between the substrate and the layer of particles with good wettability.

Another subject-matter of the present invention is a device intended to accomplish the deposition of particles of nanometric size on at least one part of the surface of a substrate, including a first enclosure intended to contain a liquid charged with the said particles of nanometric size to be deposited, in which the first enclosure is subject to a pressure higher than atmospheric pressure, and including means of heating the said liquid able to raise the liquid to its boiling temperature, a second enclosure pressurised at a pressure roughly equal to that of the first enclosure, inside which the deposition of the said nanoparticles occurs, in which means of heating are provided to heat at least a part of the surface of the substrate to the said boiling temperature, and in which the first enclosure is connected to the second enclosure to allow the second enclosure to be supplied with the liquid raised roughly to its boiling temperature, such that the liquid starts boiling when it is in contact with the said part of the heated surface.

In an advantageous example the second enclosure is formed at least partially directly by the substrate, in which the said substrate forms a channel with two open ends, in which the deposit takes place over at least a part of the surface of the channel, and in which at least one end is intended to be connected to the first enclosure.

The device according to the invention may include a second connection to return the liquid to the first enclosure after it has passed into the second enclosure, so as to form a closed circuit, the entire circuit being pressurised.

In an example embodiment the first and second enclosures are combined.

Advantageously, the device according to the invention may include means to circulate the liquid at low speed along the surface of the substrate, for example a hydraulic pump.

### BRIEF DESCRIPTION OF THE ILLUSTRATIONS

The present invention will be better understood using the description which follows and the appended illustrations, in which:

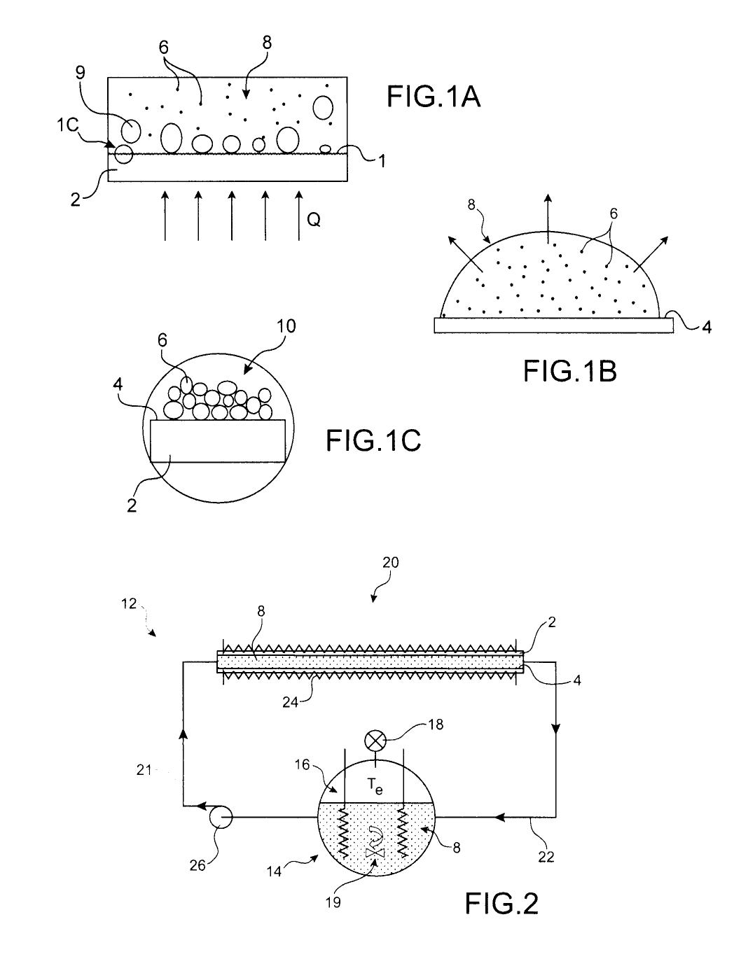

FIGS. 1A to 1C are schematic representations of the deposition steps of the method according to the present invention,

FIG. 2 is a schematic representation of an example implementation of the method according to the present invention,

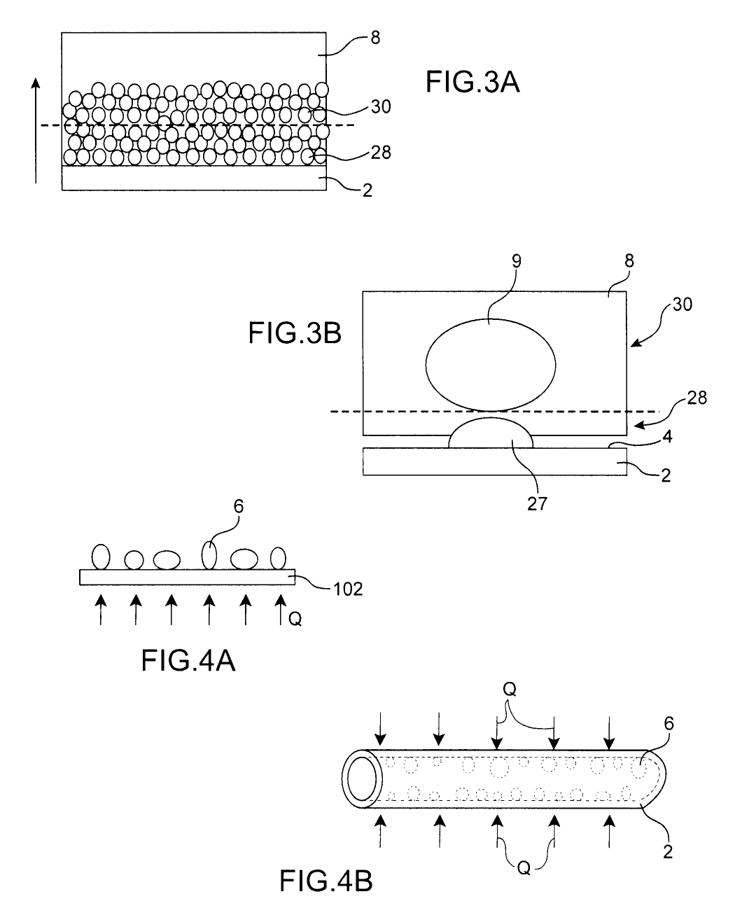

FIG. 3A is a schematic representation of a variant embodiment of a structuring which can be obtained by the method according to the present invention,

FIG. 3B is an enlarged view of FIG. 3A,

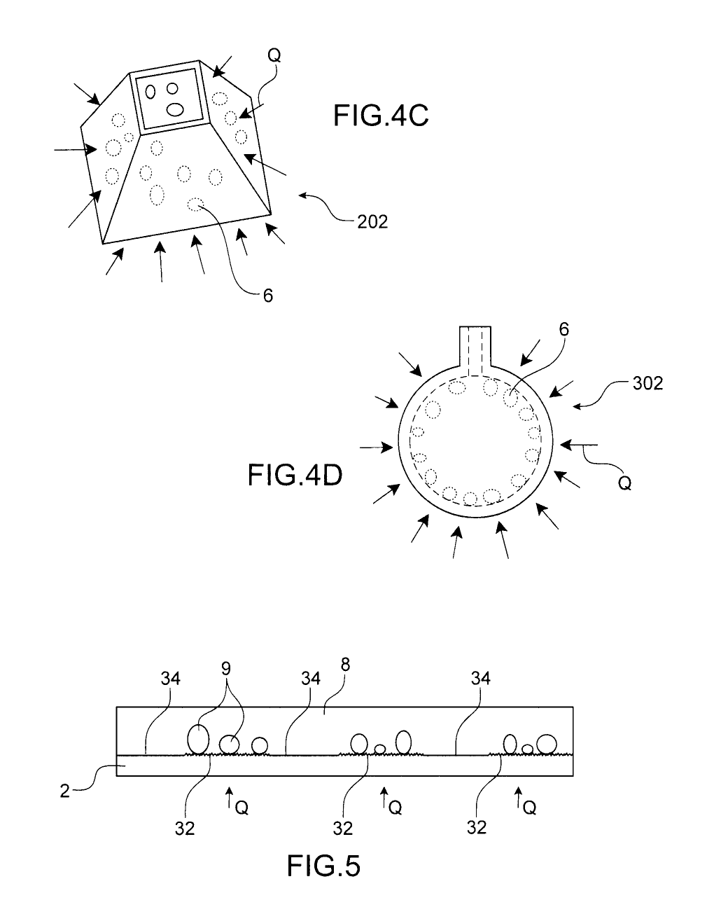

FIGS. 4A to 4D are schematic representations of various examples of surfaces capable of being structured using the method according to the present invention,

FIG. 5 is a schematic representation of a surface which has been structured, in discrete fashion, according to the present invention,

### DETAILED ACCOUNT OF PARTICULAR EMBODIMENTS

The method of deposition of nanoparticles which will be described below can be used to produce deposits on all types of objects having various functions. One advantageous application of such surfaces is thermal exchange, but the present invention is in no way limited to such an application.

In FIGS. 1A to 1C the steps of the process according to the present invention can be seen, applied to a substrate 2 having a surface 4 on which it is sought to deposit particles 6 of nanometric size, designated hereinafter nanoparticles.

According to the present invention a liquid solution containing the nanoparticles 6, called hereinafter a nanofluid 8, is used.

This solution is brought into contact with the surface 4 of the substrate 2. The nanofluid 8 is raised to a temperature close to its boiling temperature, and advantageously below its boiling temperature, and the substrate 2 is also heated roughly above the boiling temperature.

According to the present invention, it is sought to accomplish the deposition at the highest possible boiling temperature. To accomplish this, firstly a liquid is chosen having a high standard boiling temperature, and secondly the nanofluid 8 is pressurised, in order to increase the boiling temperature of the nanofluid 8, such that it is higher than its standard boiling temperature. The expression “pressurised” signifies, in the present application, subject to a pressure greater than atmospheric pressure.

Indeed, the inventors have observed that the adhesion of the deposited layer of nanoparticles was increased by increasing the temperature at which the deposition took place. The high temperature modifies the structure made compared to the prior art, and improves appreciably the adhesion of the nanoparticles to the surface 4. Indeed, according to the inventors, the high temperature allows in situ crystallisation, and increases the Van der Waals forces between the substrate and the nanoparticles.

Vapour bubbles 9 are present in the nanofluid 8, as is shown diagrammatically in FIG. 1A. The liquid, in which the nanoparticles 6 are dispersed, evaporates as is shown diagrammatically in FIG. 1B; the nanoparticles then adhere to the surface 4 of the substrate 2, and form a layer of nanoparticles 10 (FIG. 1C).

The thickness of the layer of nanoparticles 10 can be calculated using the following relationship:

δ=−\dot{δ}₀ ln(1−kt)/k (I)

where \dot{δ}₀ is the initial speed of deposition (m/s) given by the relationship (III) below, t is the boiling time, in seconds, and k is a constant defined by the following relationship (II):

$$k = \frac{{Q}_{eva}}{{υ}_{0} {ρ}_{f} {H}_{fg}} \qquad ( II )$$

where Qₑᵥₐ is the heat flow used to evaporate the liquid, in W/m².

$$δ \approx \frac{3}{2} \frac{{δ}_{m} ϕ Q}{{D}_{b} {ρ}_{g} {H}_{fg}} \qquad ( III )$$

where φ is the volume concentration of the nanoparticles in the fluid, Q is the surface heat flow in W/m, ρ_{g} is the density in the gaseous phase in kg/m³, and H_{fg} is the latent heat to change from the liquid phase to the vapour phase.

The material of the nanoparticles is, for example, TiO₂, SiO₂ or again alpha-Al₂O₃, gamma-Al₂O₃, boehmite AlO(OH), gibbsite Al(OH)₃), ZrO₂, HfO₂, SnO₂, Sb₂O₅, Ta₂O₅, Nb₂O₅, ZnO and/or silver, and the liquid containing them can be, for example, water or ethylene glycol.

The pressure of the nanofluid is such that the boiling temperature of the liquid is between 150° C. and 200° C., and the pressure is then between 5 bar and 10 bar.

FIG. 2 shows an example of a device 12 to implement the method according to the present invention, applied to the deposition of nanoparticles on the inner surface 4 of a tube 2.

The device 12 includes a first enclosure 14 in which the nanofluid 8 is intended to be raised to boiling temperature under pressure, where the first enclosure 14 is therefore fitted with means of heating represented schematically and designated by reference 16, and means of pressurisation represented schematically and designated by reference 18.

Advantageously, a stirring system 19 is provided in the first enclosure 14 to guarantee a roughly uniform concentration of particles of the nanofluid, which will be injected to accomplish the deposition.

The device also includes a second enclosure 20 in which the deposition actually occurs; a duct 21 is provided between the first enclosure 14 and the second enclosure 20 to raise the nanofluid roughly to its boiling temperature under pressure inside the second enclosure 20.

The solution including the “ready-for-deposition” nanoparticles is introduced into the second enclosure 20. The nanoparticles have been produced beforehand and added to a solution to form the nanofluid.

In the represented example the second enclosure 20 is formed directly by the tube to be treated.

A pump 26 to convey the nanofluid from the first enclosure 14 to the second enclosure 20 may be provided.

Furthermore, a duct 22 is also provided between the second enclosure 20 and the first enclosure 14 conveying the fluid from the tube to the enclosure 14.

The deposition device also includes means of heating 24 of the substrate in the second enclosure, in the represented particular case, where the means of heating are outside the first enclosure formed directly by the pipe to be covered.

These means of heating 24 may be of any type; for example they may be electrical, by electromagnetic coupling, or indirect by a heat exchanger using a fluid. It may even be decided to place the tube, and more generally the substrate, in a furnace. Every other type of heating known to the skilled man in the art is applicable.

As an example, the fluid's nanoparticle concentration can be between 0.01% and 1% by mass.

The pressure within the first enclosure 14 is between 5 bar and 10 bar and the boiling temperature is between 150° C. and 200° C.

The heat flow applied to the tube is between 0.1 W/cm² and 100 W/cm².

We shall now explain the deposition of nanoparticles according to the present invention.

The nanofluid is heated to its boiling temperature Te under 5 to 10 bar in the enclosure 14.

The tube 2 is heated roughly to the said boiling temperature Te.

When the nanofluid is at a temperature slightly below its boiling temperature it is conveyed into the heated tube 2, by means of the pump 26.

Advantageously, the nanofluid is injected a very slow speed into the tube to ensure a constant concentration of the fluid inside the tube over its entire length, and therefore a more uniform deposit along the length of the tube. The nanofluid flow speed is of the order of 0.1 m/s. This circulation has the advantage that it releases the steam bubbles generated within the nanofluid.

Advantageously, nanofluid is circulated for some considerable time, advantageously at least 10 min. to improve the homogeneity of the deposited layer. Indeed, it has been observed that the longer the duration of the deposition, the more uniform the structure of the deposited layer.

In the represented example the device operates in a closed loop, and after passing into the tube the nanofluid is returned into the enclosure, and then reinjected into the tube. In the enclosure the nanofluid is heated again. The fluid can be recharged with nanoparticles. Close-loop operation allows a fully pressurised installation to be produced, simplifying production, notably in terms of sealing. But it is understood that a device with an open circuit is not beyond the scope of the present invention.

If it is desired to produce thermal exchange surfaces for thermal exchangers, deposits of nanoparticles can be produced having good wettability properties for the fluid which will be used in the thermal exchanger. If the fluid used is water the nanoparticles have hydrophilic properties. The expression “nanoparticles having good wettability properties for a fluid” means that the material of which the nanoparticles are composed, forming a flat surface, itself has good wettability properties for the fluid, i.e. the angle of contact between the outer edge of a drop of fluid and the flat surface is less than 90°. In the case of water the surface is said to be hydrophilic. Low wettability means that the angle of contact between a drop of fluid and the flat surface is greater than 90°.

But it is understood that nanoparticles with any type of property can be deposited.

Moreover, in a variant of the method represented in FIGS. 3A and 3B where it is desired to produce a particularly effective exchange surface, a deposition of a first layer 28 of nanoparticles of low or no wettability and a deposition of a second layer 30 covering the first layer 28 of highly wetting nanoparticles are accomplished.

If the fluid used in the thermal exchanger is water or an aqueous solution, a first hydrophobic layer 28 deposited on the substrate and a second hydrophilic layer 30 deposited on the first layer 28 are therefore produced. As is shown diagrammatically in FIG. 3B, the clusters of vapour 27 appear with a lower energy due to the hydrophobic layer 28, but at the same time providing excellent properties of the very wetting surfaces due to the hydrophilic layer 30. Indeed, the hydrophilic layer 30 facilitates the detachment of the vapour bubbles 9 and the re-wetting of the surface.

This structuring therefore enables an energy to be had to initiate the lower degree of nucleation than in the case of structuring obtained only using wetting nanoparticles.

FIGS. 4A to 4D are schematic representations of various shapes of parts, part of the surfaces of which can be treated using the method according to the present invention. It can be seen that surfaces of complex shape, of the closed type, can be structured simply by the present invention.

In FIG. 4A this is a flat substrate having a flat surface 102.

In FIG. 4B it is a tube, the structuring of the inner surface of which was described in relation with FIG. 2.

In FIG. 4C the substrate 202 has the shape of a truncated pyramid with a hollow square base.

In FIG. 4D the substrate 302 has the shape of a tank-type container having an orifice.

The arrows Q symbolise the thermal flow to which the substrate is subjected for the purpose of the deposition.

Advantageously, parts forming a channel the surface of which is intended to be structured are particularly suitable for deposition according to the device of FIG. 1.

The method described in relation with FIG. 2 advantageously allows the tube to be used directly as a pressurised enclosure within which the deposition is accomplished, which simplifies the device and enables problems relating to the sizes of the substrates to be treated to be overcome, at least partially.

In the case of a substrate of open shape the device has a second enclosure separate from the substrate, and the latter is placed inside the second enclosure. In this case structuring will take place on all the surfaces of the substrate accessible to the nanofluid.

A deposition device having a single pressurised enclosure in which the nanofluid is heated to its boiling temperature, and in which the substrate is immersed and heated, is also conceivable. In this case the deposition of nanoparticles takes place over all the surfaces of the substrate which are accessible to the nanofluid.

The device of FIG. 2 is particularly suitable for structuring closed surfaces, and has the advantage that it structures substrates of any sizes, since the latter are not limited by the size of an installation into which the substrate would have to be introduced.

Moreover, it is possible to accomplish the deposition on various types of materials, since the boiling temperature of the nanofluid can be adjusted by modifying the pressure present in the device, according to the material. It can therefore be envisaged to accomplish deposition on polymers, for example PC (polycarbonate) or PEEK (Polyetheretherketone), PEI (Polyetherimide), PSU (Polysulfone), PPSU (Polyphenylsulfone), PA (Polyamide), POM (Polyoxymethylene), PBI (Polybenzimidazole), PPS (Polyphenilene sulphide) on metallic materials.

Moreover, the process according to the invention allows faster and more uniform deposition than in the case of deposition at atmospheric pressure.

In addition, the deposit obtained using the invention is porous, the effect of which is to increase the surface specific area, which is favourable for re-wetting in the case of a thermal exchanger.

The porosity of the deposit is between 25% and 80%, and advantageously of around 40%.

The porosity of the deposit obtained according to the invention is also favourable in the case, for example, of nanoparticles used as a catalyst. Nanoparticles acting as a catalyst, such as Pd, Pt, Ni or CeO can be used, or the support can be produced in a nanoporous form in order to deposit catalyst particles on it.

In the examples described above it is sought to produce a uniform and continuous deposit on a surface of a substrate. But, using the invention, it is also possible to accomplish, very simply, a discrete structuring of the surface, as is represented in FIG. 5. The surface of the substrate includes zones 32 which it is sought to cover with a layer of nanoparticles, and zones 34 which it is sought not to cover with nanoparticles. To accomplish this it is sufficient only to heat the zones 32 where it is sought to accomplish a deposition of nanoparticles. In this case heat flows Q are applied in zones 32, whilst the boiling nanofluid is circulated both over the heated zones 32 and over the non-heated zones 34. Deposition is then accomplished locally in the heated zones 32.

Tests have been made to show the effectiveness of the method according to the present invention for the adhesion of the particles on the substrate.

The tests consisted in accomplishing the depositions of nanoparticles on a heated surface using a drop of nanofluid. In the present case this is SiO₂ in water. The substrate is made from aluminium. Depositions with three heating temperatures of the substrate and of the nanofluid were accomplished, 80° C., 110° C. and 175° C.

The nanoparticles are deposited on the surface of the substrate. Part of the surface is then abraded using a device called a “Taber 5750®”.

Visually it was observed that the higher the temperature the more uniform the deposit.

The adhesion of the deposited particles was measured by measuring the profile of the abraded and non-abraded surfaces by means of a profilometer, and the percentage of the particles removed by abrasion for each temperature is shown in the table below:

| Deposition temperature | Percentages of particles removed by abrasion |
|---|---|
| 80° C. | 75% |
| 110° C. | 50% |
| 175° C. | 33% |

It is observed that the higher the deposition temperature the better the adhesion of the nanoparticles on the substrate.

The method of deposition according to the present invention is particularly suitable for the production of diphasic thermal exchangers, diphasic thermosiphons, heat pipes and to accomplish hydrophilic or hydrophobic treatments of surfaces.

1-14. (canceled)

15. A method of depositing at least one nanometric particle on at least one part of a surface of a substrate, the method comprising:
a) heating a liquid comprising the at least one particle of nanometric size to a temperature close to a boiling temperature of the liquid;
b) heating the at least one part of the surface of the substrate to a temperature roughly equal to the boiling temperature;
c) bringing the liquid into contact with the surface;
d) boiling the liquid on the surface at a temperature higher than a standard boiling temperature of the liquid, causing a deposition of the at least one particle on the surface,
wherein a), b), and c) occur at a pressure higher than atmospheric pressure.

16. The method of claim 15, wherein c) is accomplished by flowing the liquid along the surface.

17. The method of claim 16, wherein the flowing of the liquid along the surface takes place at a speed of less than or equal to 0.1 m/s.

18. The method of claim 15, wherein the pressure applied is between 5 bar and 10 bar, so as to have a boiling temperature of the liquid of between 150° C. and 200° C.

19. The method of claim 15, wherein a concentration of particles in the liquid is between 0.01% and 1% by mass.

20. The method of claim 18, wherein a concentration of particles in the liquid is between 0.01% and 1% by mass.

21. The method of claim 15, wherein the at least one particle comprises the particle at least one material selected from the group consisting of TiO₂, SiO₂, alpha-Al₂O₃, gamma-Al₂O₃, boehmite AlO(OH), gibbsite Al(OH)₃), ZrO₂, HfO₂, SnO₂, Sb₂O₅, Ta₂O₅, Nb₂O₅, ZnO, and silver, and
the liquid is water or ethylene glycol.

22. The method of claim 15, wherein the surface is heated in at least one discrete zone.

23. A method for producing a thermal exchange surface of a thermal exchanger by implementing a deposition of at least one nanometric particle on at least one part of a substrate surface, the method comprising:
a) heating a liquid comprising the at least one particle of nanometric size to a temperature close to boiling temperature of the liquid;
b) heating the at least part of the substrate surface to a temperature roughly equal to the boiling temperature;
c) bringing the liquid into contact with the surface;
d) boiling the liquid on the surface at a temperature higher than a standard boiling temperature of the liquid, causing a deposition of the at least one nanometric particle on the surface;
wherein a), b), and c) occur at a pressure higher than atmospheric pressure,
wherein the at least one particle deposited has good wettability for a thermal exchange fluid employed in a thermal exchanger.

24. The method of claim 23, wherein, prior to deposition of the at least one particle having good wettability, a first phase is accomplished by a method comprising a), b), and c),
wherein the particles are particles having low wettability for the thermal exchange fluid, so as to form a layer of particles of low wettability between the substrate and the layer of particles with good wettability.

25. A device, comprising:
a first enclosure suitable to contain a liquid charged with at least one particle of nanometric size to be deposited, wherein the first enclosure is subject to a pressure higher than atmospheric pressure;
a first heater of the liquid able to raise the liquid to a boiling temperature of the liquid;
a second enclosure pressurized at a pressure roughly equal to that of the first enclosure, inside which a deposition of the at least one particle occurs;
a second heater suitable to heat at least a part of a surface of a substrate to the boiling temperature of the liquid;
wherein the first enclosure is connected to the second enclosure to allow the second enclosure to be supplied with the liquid raised roughly to its boiling temperature, such that the liquid starts boiling when it is in contact with a part of a heater substrate surface, and
wherein the device is suitable to accomplish the deposition of the at least one particle of nanometric size on at least one part of a surface of a substrate.

26. The device of claim 25, wherein the second enclosure is formed at least partially directly by the substrate,
wherein the substrate forms a channel with two open ends,
wherein the deposition occurs over at least a part of the surface of the channel, and
wherein at least one end of the channel can be connected to the first enclosure.

27. The device of claim 25, further comprising:
a second connection to return the liquid into the first enclosure after it passes into the second enclosure, so as to form a closed circuit,
wherein the entire circuit is pressurized.

28. A device of claim 25, wherein the first and second enclosures are combined.

29. The device of claim 25, further comprising:
a hydraulic pump to circulate the liquid at low speed along the surface of the substrate.
